(19) United States
(12) Patent Application Publication
(10) Pub. No.: US 2016/0016119 A1
(43) Pub. Date: Jan. 21, 2016

(54) APPARATUS FOR FILTRATION AND DESALINATION AND METHOD THEREFOR

(71) Applicant: Roc8Sci Co., Arcadia, CA (US)

(72) Inventors: Frank Thomas Hartley, Arcadia, CA (US); Axel Scherer, Barnard, VT (US)

(21) Appl. No.: 14/800,379

(22) Filed: Jul. 15, 2015

Related U.S. Application Data
(60) Provisional application No. 62/024,559, filed on Jul. 15, 2014.

(51) Int. Cl. B01D 61/46; B01D 63/08; C02F 1/44; C02F 1/46

(52) U.S. Cl. CPC B01D 61/46; C02F 1/4604; C02F 1/4608; B01D 63/08; C02F 1/44; C02F 2201/46115

(57) ABSTRACT

A free-pass-through fluid-purification system is disclosed, wherein the system includes a pore-matrix membrane subtended between a pair of chambers of a manifold. The membrane includes a large open-fraction porous matrix that allows liquid to pass freely through; however, suspended matter having a physical cross-section larger than the size of the pores are blocked. In some embodiments, the cross-sections of the pores are made to be a small fraction of the cross-section of the suspended materials. In some embodiments, electrodes are included on the top and bottom surfaces of the membrane to enable deionization of the fluid.

### CROSS REFERENCE TO RELATED APPLICATIONS

This application claims the benefit of U.S. Provisional Patent Application Ser. No. 62/024,559, filed Jul. 15, 2014, entitled “Apparatus for Filtration and Desalination and Method Therefor,” (Attorney Docket: 550-005PR1), which is incorporated herein by reference.

If there are any contradictions or inconsistencies in language between this application and the case that has been incorporated by reference that might affect the interpretation of the claims in this case, the claims in this case should be interpreted to be consistent with the language in this case.

### FIELD OF THE INVENTION

The present invention relates to water filtration and desalination systems.

### BACKGROUND OF THE INVENTION

Limited access to clean water is at the root of many issues currently affecting the populations in developing countries.

Pathogens in drinking water and contaminated food cause infectious diarrhea, which contributes to the deaths of millions of adults and young children each year.

Helminthic infections of multicellular organisms transmitted in water, such as Lymphatic Filariasis, affects more than 120 million people worldwide, mainly in India and Africa; Onchocerciasis causes acute and chronic inflammation of the eyes and skin, affecting nearly 18 million people in Africa and the Americas, blinding 270,000, and leaving 500,000 people with visual impairment; Schistosomiasis infects 200 million people in the developing world, first manifests in adolescence and causes urinary, renal, and liver damage in adults; Cysticercosis (caused by ingestion of the human tapeworm during its larval stages) affects 50 million people in Latin America, Asia, and Africa and is the most common cause of epilepsy in endemic regions; Dracunculiasis (Guinea Worm) causes a disabling condition that leaves people unable to work or attend school; and intestinal nematodes such as Ascaris lumbricoides (the roundworm), Necator americanus and Ancylostoma duodenale (the hookworms), and Trichuris trichiura (the whipworm); infects more than a quarter of the world's population producing anemia in children and pregnant women (44 million pregnancy and delivery deaths), or stunt growth and development; and Kinetoplastid diseases, involving single-cell parasites transmitted by an insect vector in water, infect 120 million people in the third world.

Forty millions of children under the age of 5 suffer from these infections and whose lives could be saved each year through universal access to quality potable water. Removal of infectious organisms from water would alleviate pain, suffering and/or death of half a billion people worldwide. Countries with high child mortality live in a ‘healthcare desert’, measured by low immunization coverage and lack of access to treatment for basic illness.

Improvement in the capability for removing pathogens and organisms from drinking water could prevent many, if not all, of these infectious diseases.

### SUMMARY OF THE INVENTION

The present invention enables a fluid-purification system without some of the costs and disadvantages of the prior art. Embodiments in accordance with the present invention can enable: improved recovery of water from oil and petroleum processing, such fracking, oil drilling, etc.; conversion of putrid and/or salt water from nearly any source into drinking water; recovery of water from slag ponds formed during strip mining, and the like. The present invention enables fluid-purification systems having no moving parts, no consumables, minimal (if any) energy consumption, and no recurring expenses.

An illustrative embodiment of the present invention is a two-chamber, free-pass-through purifier that is operative for converting non-drinkable, putrid and/or parasite-loaded water into drinkable water. The purifier comprises a pore-matrix membrane subtended between a pair of chambers of a manifold. The membrane includes a large open-fraction porous matrix that allows liquid to pass freely through; however, suspended matter having a physical cross-section larger than the size of the pores are blocked. In some embodiments, the cross-section of each pore is a small fraction of the cross-section of the suspended materials. As a result, the pore matrix appears “smooth” to suspended materials as they flow across the manifold thereby mitigating physical interaction between the suspended matter and the pores. In other words, the membrane pores are neither “noticed” nor blocked by the suspended matter during normal operation. In contrast to conventional filtration systems, therefore, periodic backwashing is not necessary in some embodiments of the present invention.

In some embodiments, a membrane includes electrodes on its outer surfaces. When a voltage is applied across these electrodes, the resultant electric field develops a repulsion zone at each pore converting them into ion-selective nano-channels that enable the membrane to separate water into ion-free and ion-concentrated streams. Such embodiments enable, for example, a continuous supply of fresh water to be obtained from sea water using only a small battery and the gravity flow of water.

An embodiment of the present invention is a water purification system for separating a liquid from a fluid comprising a contaminant, the system comprising: a first chamber that is fluidically coupled with an inlet and a first outlet; a second chamber that is fluidically coupled with a second outlet; and a first membrane that includes a first grid and a first plurality of pores, the first plurality of pores collectively defining a first open-fraction porous matrix that is operative for (1) allowing the liquid to pass through the first membrane and (2) blocking the contaminant from passing through the first membrane, wherein the first membrane is located between the first chamber and the second chamber; wherein the first chamber, second chamber, and first membrane are arranged such that the fluid flows from the inlet to the first outlet along the surface of the first membrane to enable (1) at least a portion of the liquid to exit the fluid through the first membrane and enter the second chamber and (2) the contaminant to flow along the surface of the first membrane to the first output.

### BRIEF DESCRIPTION OF THE DRAWINGS

FIG. 1A depicts a schematic drawing of salient features of a fluid-purification system in accordance with an illustrative embodiment of the present invention.

FIG. 1B depicts the fluid flow through system 100.

FIG. 1C depicts a top view of membrane 106.

FIG. 2 depicts operations of a method for purifying a fluid in accordance with the illustrative embodiment of the present invention.

FIG. 3A depicts a schematic drawing of salient features of a fluid-purification and deionization system in accordance with a first alternative embodiment of the present invention.

FIG. 3B depicts a schematic drawing of a detailed view of an energized pore 124 in accordance with the first alternative embodiment.

FIG. 4 depicts operations of a first method for purifying and deionizing a fluid in accordance with the first alternative embodiment of the present invention.

FIG. 5 depicts a schematic drawing of a system operative for purifying and deionizing a fluid in accordance with a second alternative embodiment of the present invention.

FIG. 6 depicts operations of a first method for purifying and deionizing a fluid in accordance with the second alternative embodiment of the present invention.

### DETAILED DESCRIPTION

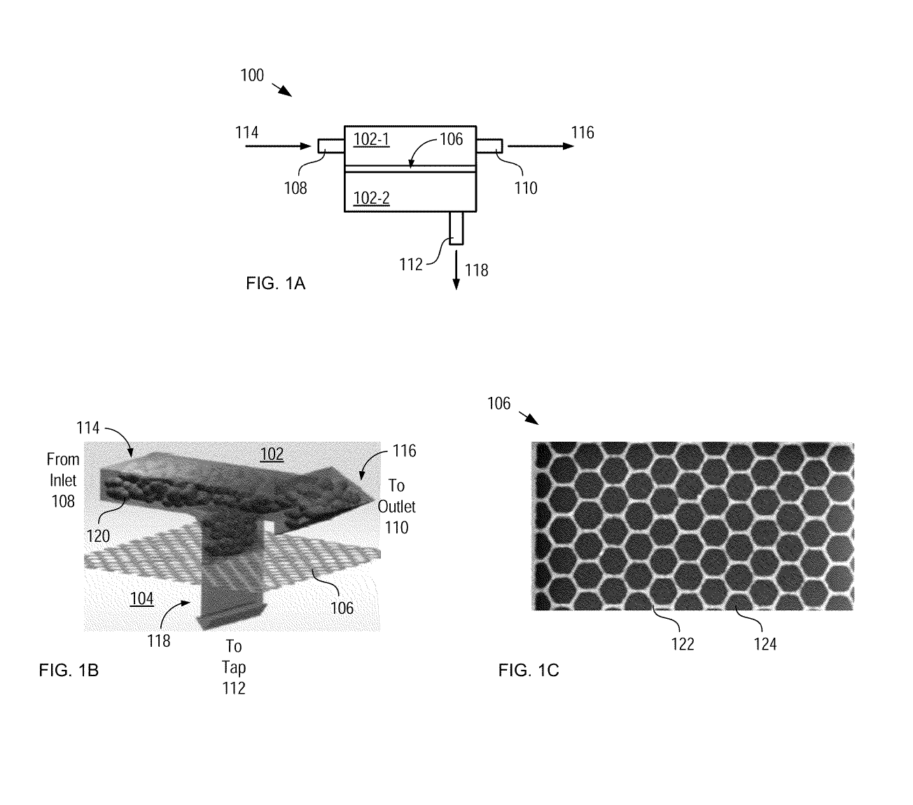

FIG. 1A depicts a schematic drawing of salient features of a fluid-purification system in accordance with an illustrative embodiment of the present invention. System 100 includes chambers 102-1 and 102-2, membrane 106, inlet 108, outlet 110, and tap 112.

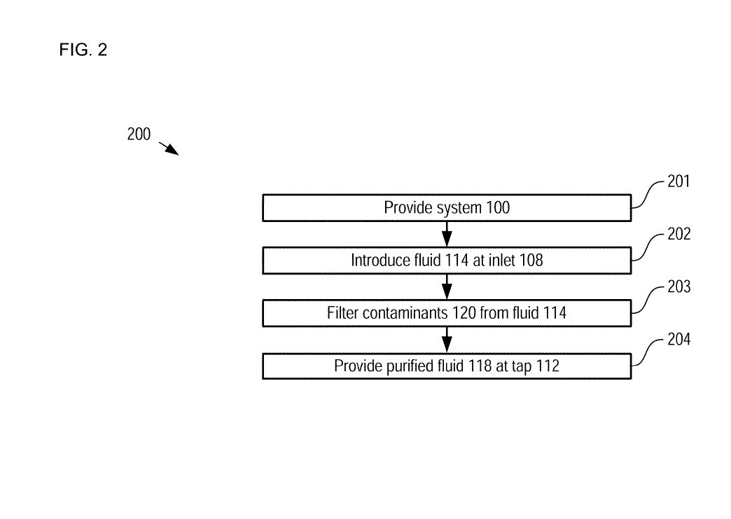

FIG. 2 depicts operations of a method for purifying a fluid in accordance with the illustrative embodiment of the present invention. Method 300 begins with operation 201, wherein system 100 is provided.

System 100 is provided such that chambers 102-1 and 102-2 are disposed on either side of membrane 106. Each of chambers 102-1 and 102-2 is a conventional conduit-like chamber. Chamber 102-1 is fluidically coupled to inlet 108 and outlet 110. Chamber 102-2 is directly fluidically coupled to tap 112. As a result, chamber 102-1 is fluidically coupled to tap 112 only through membrane 106.

At operation 202, fluid 114 is introduced to system 100. Fluid 114 enters chamber 102-1 at inlet 108 and flows along the length membrane 106 to outlet 110, where it is ejected as outflow 116.

FIG. 1B depicts the fluid flow through system 100.

Fluid 114 contains liquid 118 and contaminants 120. In the illustrative embodiment, liquid 118 is water and contaminants 120 include at least one of bacteria, parasites, and colloidal suspensions, such as silt, decomposing organic matter, mold, etc. Although the illustrative embodiment is a fluid-purification system that is operative for providing clean drinking water, it will be clear to one skilled in the art, after reading this Specification, how to specify, make, and use alternative embodiments of the present invention that are suitable for use in other applications, such as fracking fluid recovery, petrochemical filtration, mining waste-water recovery, and the like.

FIG. 1C depicts a top view of membrane 106.

At operation 203, fluid 114 is filtered by membrane 106.

Membrane 106 is an “open-fraction” porous matrix comprising grid 122 and pores 124. Pores 124 are dimensioned and arranged to filter fluid 114, thereby enabling liquid 118 to pass freely through the membrane to tap 112, but restricting the passage of contaminants 120 through membrane 106 and into chamber 102-2. Typically, pores 124 have a physical cross-section smaller than the suspended matter in fluid 114.

Pores 124 have a diameter of approximately 300 nm, which is smaller than the cross-section of typical bacteria. As a result, purified (bacteria-free) water is readily extracted from the cross-flow of putrid water through chamber 102-1. Further, single- and multi-cell parasites, as well as suspended silts, are larger than a typical bacterium. A pore size of 300 nm, therefore, would also be effective for extracting these from the cross-flow of fluid 114 and blocking them from passage through membrane 106. It should be noted that 300 nm is merely an exemplary size for pores 124 and that other pore sizes can be used without departing from the scope of the present invention.

In the illustrative embodiment, membrane 106 is fabricated by anodizing a raw sheet of aluminum foil to produce a plurality of nanometer-scale pores through the sheet. In some embodiments, the anodization process is terminated before the aluminum is completely anodized, thereby leaving the raw aluminum material available for use as an electrical conductor.

In some embodiments, membrane 106 is fabricated by forming a mandrel having a plurality of nanometer-scale-diameter projections. The mandrel is then used to puncture grid material as it passes under the mandrel to form pores 124. The use of such a mandrel is particularly well suited for use in manufacturing processes such as reel-to-reel transfer, tape casting, tape-transfer, etc.

In some embodiments, membrane 106 is fabricated by first forming a pre-form comprising a plurality of cylinders and drawing the pre-form (typically while heated) down until the inner diameter of each cylinder is equal to the desired pore size. Suitable materials for use in the cylinders include, without limitation, glasses, plastics, composite materials, and the like. Once the preform has been drawn to the desired pore size, it is sliced to singulate individual membranes.

In some embodiments, membrane 106 is formed by etching pores 124 in a suitable substrate via a conventional etch process, such as deep-reactive-ion etching (DRIE), laser-assisted etching, focused-ion beam (FIB) etching, LIGA, LIGA-like processes, and the like.

In some embodiments, membrane 106 is mounted to a larger-pore backing structure to provide additional mechanical strength to the composite membrane.

It should be noted that system 100 requires no moving parts, consumables, little or no energy dissipation (save small gravity head), or recurring costs during operation.

Due to the large open fraction of the nano-pore matrix of membrane 106, a low energy/gravity head is required to pressure the flow-rates across and through the membrane. This is particularly true in embodiments wherein liquid 118 is water. In some embodiments, the open fraction of the matrix defined by pores 124 is greater than 50%. In some embodiments, the largest cross-sectional dimension (e.g., diameter) of each pore 124 is no greater than 30% of the smallest dimension of any contaminant included in contaminant 120. In embodiments wherein the cross-section of each of pores 124 is a small fraction (e.g., ≦30%) of the cross-section of contaminants 120, the pores are substantially invisible to the contaminants (i.e., they do not perturb the flow of the contaminants across the surface of the membrane, nor do the pores become blocked by the contaminants). As a result, system 100 mitigates the need for periodic backwashing required by most prior-art filtration systems. In other words, membrane 106 will appear smooth to the suspended materials as they flow across it.

At operation 204, filtered liquid 118 is provided at tap 112.

It is another aspect of the present invention that the capabilities of system 100 can be augmented to provide desalination (or other deionization) of fluid 114 by energizing conductive layers disposed on the outer surfaces of grid 122 to create an electric field. Such a configuration enables an efficient and non-fouling desalination process based on a fundamental electrochemical-transport phenomenon in which a charged element is passed or repelled by a polarized electric field. For the purposes of this Specification, including the appended claims, a “charged element” is defined as an element having an electric charge other than neutral. Examples of charged elements, in accordance with this Specification, include, without limitation, cations, anions, charged colloids, charged particles, suspended solids having a non-zero charge, charged proteins, microorganisms, and the like. This phenomenon is exploited in embodiments of the present invention as a simple mechanism for removing salts from a fluid. Such embodiments are, therefore, afforded significant advantages over more complicated prior-art approaches, such as reverse osmosis or electrodialysis. It should be noted that this mechanism can be employed to remove not only salts, but also any charged colloids in the source water, fundamentally eliminating the potential for membrane fouling and clogging and significantly reducing the complexity and cost of direct desalination. Such embodiments of the present invention are particularly well suited for use in desalinization plants for providing drinking water from seawater, deionized-water systems used in integrated-circuit fabrication labs or biological labs, and the like.

Traditional electrodialysis has inherent limitations and is most effective for removing low-molecular-weight ionic components from concentrated feed streams. It is less effective for use with extremely low salt concentrations and higher-molecular-weight, less-mobile ionic species, however. This is due to the fact that electrodialysis requires substantial conductive feeds, while current density decreases as the feed-salt concentration becomes lower, and both ion transport and energy efficiency declines.

The present invention enables a new form of an electrodialysis process that relies on the principle that most dissolved salts are positively or negatively charged and, therefore, will migrate to electrodes with an opposite charge. Instead of using selective membranes that are able to allow passage of either anions or cations to make separation possible, however, the present invention relies on the use of electric fields to selectively pass anions while simultaneously blocking the path of cations (or, using the opposite electric field, pass cations while blocking the path of anions). Nano-pore matrices suitable for providing locally high field gradients in pore environments, in accordance with the present invention, are neither conductive feeds nor current density related. As a result, they exhibit none of the inherent limitations of conventional electrodialysis.

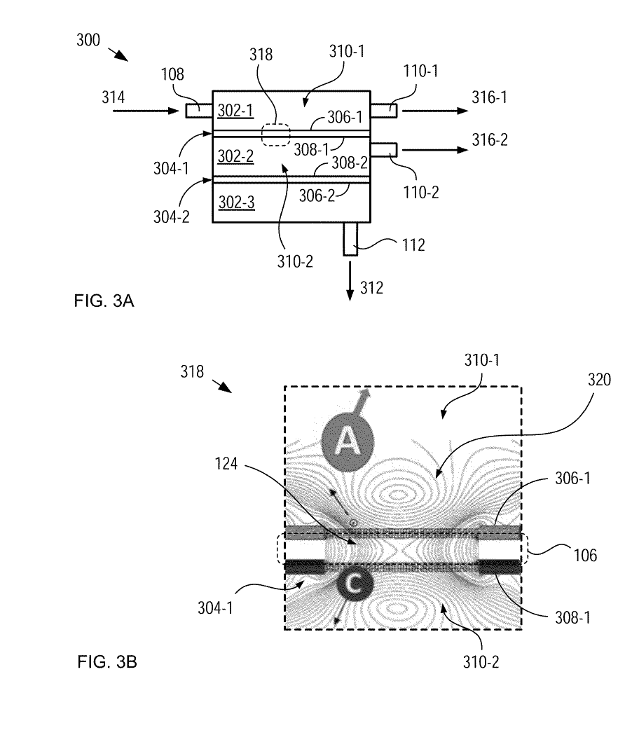

FIG. 3A depicts a schematic drawing of salient features of a fluid-purification and deionization system in accordance with a first alternative embodiment of the present invention. System 300 includes chambers 302-1, 302-2, and 302-3, membranes 304-1 and 304-2, inlet 108, outlets 110-1 and 110-2, and tap 112. System 300 is analogous to system 100; however, system 300 has the additional capability of deionization.

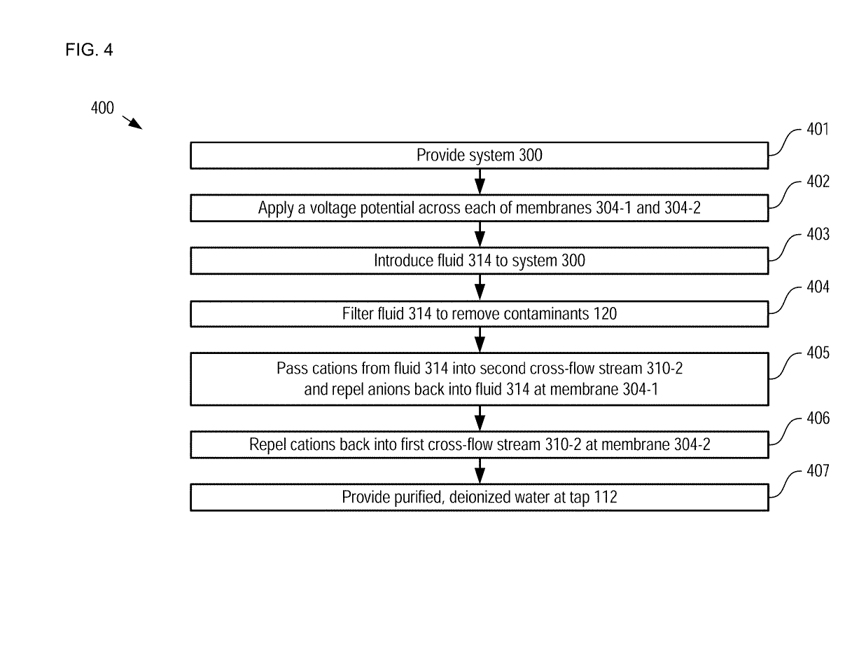

FIG. 4 depicts operations of a first method for purifying and deionizing a fluid in accordance with the first alternative embodiment of the present invention. Method 400 begins with operation 401, wherein system 300 is provided.

System 300 is a non-limiting, exemplary configuration of a filtration and deionization system in accordance with the present invention. System 300 is provided as a three-chamber plastic manifold that is 25-cm wide, 50-cm deep, and under 2.5-cm thick. Such a system could supply more than 40 liters of purified water per hour from nearly any source of compromised water. Such a system would be further capable of operating continuously for more than 20 hours per day in all weather conditions when provided with contiguous water and power. One skilled in the art will recognize, after reading this Specification, that myriad alternative configurations of system 300 are possible (e.g., a different number of chambers, one or more different size chambers, etc.) without departing from the scope of the present invention.

Each of chambers 302-1, 302-2, and 302-3 is a conventional conduit-like chamber that is analogous to chamber 102. Chambers 302-1 and 302-2 are disposed on either side of membrane 304-1 and chambers 302-2, 302-3 are disposed on either side of membrane 304-2.

Each of membranes 304-1 and 304-2 is an electrically active membrane that includes electrical conductors on each of the top and bottom surfaces of a membrane 106. The presence of these conductors enables generation of large potential gradients over the entirety of the sub-micron-scale pore apertures, as well as through the micron-scale pore thickness, with a voltage of only a few volts applied between the conductors.

At operation 402, a voltage potential is applied across the electrodes of each of membranes 304-1 and 304-2. The voltage potential across each membrane energizes each of its pores 124, thereby giving rise to an ion repulsion zone at each pore.

FIG. 3B depicts a schematic drawing of a detailed view of an energized pore 124 in accordance with the first alternative embodiment. Region 318 includes a single pore 124 and is representative of a region of either of membranes 304-1 and 304-2.

At operation 403, input fluid 314 is introduced into system 300. Input fluid 314 is analogous to fluid 114 described above and with respect to FIGS. 1A-B; however, fluid 314 includes liquid 320 and contaminants 120, where liquid 320 is saltwater. Input fluid 314 enters chamber 302-1 at inlet 108 and flows as first cross-flow stream 310-1 along the length membrane 304-1 to first effluent outlet 110-1.

At operation 404, membrane 304-1 inhibits the passage of contaminants 120 from fluid 314 into second cross-flow stream 310-2. The physical filtering functionality of membrane 304-1 is analogous to that described above and with respect to membrane 106.

At operation 405, membrane 304-1 passes cations from fluid 314 into second cross-flow stream 310-2 while rejecting anions back into first cross-flow stream 310-1.

The deionization mechanism of the present invention relies upon the development of repulsion zone 320 within, and around, each pore 124 of membranes 304-1 and 304-2. One skilled in the art will recognize that the field gradient of the membrane dictates which of cations or anions are repelled by these repulsion zones. As a result, each of pores 124 preferentially conducts its respective anions or cations through the pore along with the through-flow water stream. It should be noted that deionization does not rely on the physical filtering mechanism provided by the membranes.

Cathode 306-1 is located on the upper surface of membrane 304-1 (i.e., proximal to chamber 304-1) and anode 308-1 is located on its lower surface (i.e., proximal to chamber 304-2).

The high field gradients associated with cathode 306-1 simultaneously attract positive ions (cations) from first cross-flow stream 310-1 and repel negative ions (anions). The cations pass through each pore 124 of the membrane and enter second cross-flow stream 310-2. The anions are forced back into first cross-flow stream 310-1 and do not enter into second cross-flow stream 310-2 in chamber 302-2. The now anion-rich first cross-flow stream 310-1 is ejected from system 300 at first outlet 110-1.

Membrane 304-2 is located below membrane 304-1 such that chamber 302-2 is located between them. Membrane 304-2 is arranged such that its anode 308-2 is on its upper surface (i.e., proximal to chamber 302-2) and its cathode 306-2 is located on its lower surface (i.e., proximal to chamber 302-3).

At operation 406, anode 308-2 repels positive ions (cations) back into second cross-flow stream 310-2 in chamber 302-2. As a result, cations are not allowed to pass through second membrane 304-2 and into liquid 312. Instead, the cations remain in the now cation-rich second cross-flow stream 310-2, which is ejected from system 300 at second outlet 110-2.

At operation 407, system 300 provides purified, deionized water at tap 112.

Since virtually all anions in first cross-flow stream 310-1 are blocked by membrane 304-1, the through-flow of fluid through membrane 304-2 is substantially deionized. In other words, by virtue of the dual operation of electrically active membranes 304-1 and 304-2, chamber 302-3 receives only deionized water from chamber 302-2. Liquid 312 (i.e., the deionized water) is provided by system 300 at tap 112. As a result, with these dual membranes in a three-chamber manifold, and with voltages applied across the nano-pores of the two cascaded large “open-fraction” nano-pore matrices, salts (and/or other ionic materials) are scrubbed out of input fluid stream 314.

In some embodiments, the polarity of the voltage potentials applied to each of membranes 304-1 and 304-2 (i.e., the positions of their cathodes and anodes) is reversed; therefore, membrane 304-1 passes anions into second cross-flow stream 310-2 while rejecting cations into first cross-flow stream 310-1, and membrane 304-2 blocks the passage of anions into liquid 312.

When a voltage is applied across the several-micrometers-deep channels (i.e., pores 124) of membranes 304-1 and 304-2, salts are repelled from the through-flowing water by the pores as the salinized water flows across the membranes—without any of the ions actually coming in contact with pores 124. It should be noted that this cross-flow filtration substantially eliminates all charged particles from fluid 314. In other words, the voltage potential repels more than just salts, thereby also aiding in the rejection of suspended solids, charged proteins, microorganisms, and the like. For example, cross-flow filtration systems in accordance with the present invention can also remove weakly ionized materials such as dissolved silica, carbon dioxide and some organic matter.

It should be noted that the flow-rate through system 300 is generally determined by a low-energy, gravity head pressure, as well as the width of manifold structure. The aggregate flow rate through the large “open-fraction” nano-pore matrices is established by the cross-sectional area of the nano-pore matrices (i.e., the pore structure of membrane 106).

The operating voltage across membranes 304-1 and 304-2 can be less than 0.2 volts for low-energy applications. When operated at 0.2 volts, the energy to desalinate seawater to drinking water is less than 1.5 Wh/L. As a result, the exemplary embodiment depicted herein would require only 60 Watts of energy to supply 40 liters of purified water per hour—less than 2.5 Wh/L. In some embodiments this energy is supplied by a solar panel (e.g., having 1 KW storage capacity) and associated battery system. This would suffice, in moderate climate locations, to power a desalination operation continuously. An exemplary power system could include a single high performance crystalline solar panel (dimensions 50″L×27″W×2″H—1.6 cubic feet, and weight of approximately 14 lbs.) and 12 volt controller and storage battery. The combined volume of the manifold/fixtures and solar panel/storage systems would, therefore, be approximately 5 cubic feet having a combined weight of approximately 32 lbs. Such a filter-and-power system would be easily transportable by small vehicle and hand carried. If a liquid-fuel-energy-sourced power supply were available, the volume of manifold/fixtures would be several cubic feet and with a dry weight of only 12 lbs.

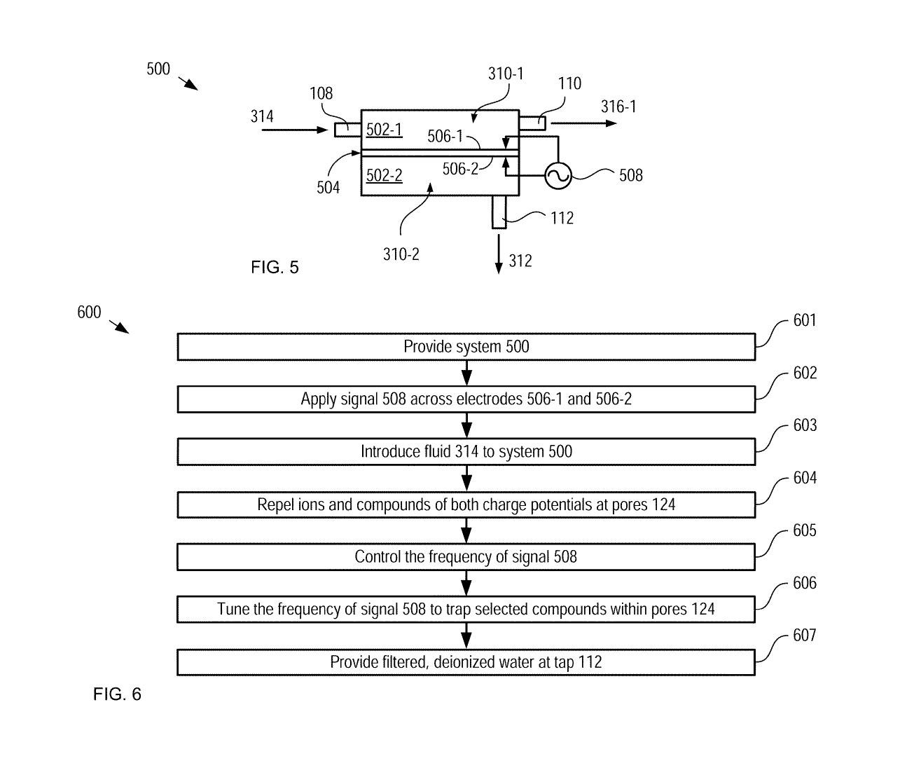

FIG. 5 depicts a schematic drawing of a system operative for purifying and deionizing a fluid in accordance with a second alternative embodiment of the present invention. System 500 includes chambers 502-1 and 502-2, membrane 504, inlet 108, outlet 110, and tap 112. System 500 is analogous to one half of system 300.

FIG. 6 depicts operations of a first method for purifying and deionizing a fluid in accordance with the second alternative embodiment of the present invention. Method 400 begins with operation 601, wherein system 500 is provided.

System 500 is provided such that chambers 502-1 and 502-2 are analogous to chambers 102-1 and 102-2 described above.

Membrane 504 comprises membrane 106 and electrodes 506-1 and 506-2, which are disposed on opposite surfaces (i.e., the top and bottom surfaces) of grid 122.

At operation 602, signal 508 is applied to electrodes 506-1 and 506-2. Signal 508 is an alternating current (AC) voltage signal is applied to electrodes 506-1 and 506-2. Signal 508 gives rise to a filtration mechanism wherein repulsion zone 320 develops within and around pores 124 of membrane 504 such that repulsion zone 320 is an alternating repulsion zone.

At operation 603, fluid 314 is introduced to system 500 at inlet 108.

At operation 604, ions and compounds of both charge potentials are repelled at the repulsion zones 320 arising at pores 124. The ions and charged compounds are repelled by the repulsion zones in proportion to their respective effective mobility.

When the frequency of signal 508 is sufficiently high, even the most agile of charged compounds are repelled at pores 124 and, therefore, prevented from passing through membrane 504. As a result, total desalination of the through-flow water stream (i.e., liquid 312) is achieved using only a single membrane 504. As the frequency of the signal 508 is reduced, the alternating repulsion zones 320 within and around pores 124 of each of the membranes repels fewer of the more agile charged compounds at the pores and enable passage of these higher mobility charged compounds to pass through the pore along with the through flow water stream.

At operation 605, the frequency of signal 508 is controlled to achieve a desired charged-compound mobility quotient for those ions and charged compounds allowed to pass through the pores as part of the through-flow water stream. It should be noted that the charged compounds allowed to pass incorporates all charged compounds with a mobility greater or equal to quotient. All charged compounds with mobility less than this quotient are repelled at pores 124 and, therefore, prevented from passing through membrane 504.

At optional operation 606, the frequency of signal 508 is tuned to trap compounds with a specific mobility within the pores, while passing all charged compounds with a greater mobility and repelling all charged compounds with lower mobility.

At operation 607, filtered, deionized water is provided at tap 112.

It is to be understood that the disclosure teaches just exemplary embodiments and that many variations of the invention can easily be devised by those skilled in the art after reading this disclosure and that the scope of the present invention is to be determined by the following claims.

What is claimed is:

1. A fluid treatment system for separating a liquid from a fluid comprising a contaminant, the system comprising:
a first chamber that is fluidically coupled with an inlet and a first outlet;
a second chamber that is fluidically coupled with a second outlet; and
a first membrane that includes a first grid and a first plurality of pores, the first plurality of pores collectively defining a first open-fraction porous matrix that is operative for (1) allowing the liquid to pass through the first membrane and (2) blocking the contaminant from passing through the first membrane, wherein the first membrane is located between the first chamber and the second chamber;
wherein the first chamber, second chamber, and first membrane are arranged such that the fluid flows from the inlet to the first outlet along the surface of the first membrane to enable (1) at least a portion of the liquid to exit the fluid through the first membrane and enter the second chamber and (2) the contaminant to flow along the surface of the first membrane to the first output.

2. The system of claim 1 wherein the first plurality of pores is dimensioned and arranged to mitigate perturbation of the flow of the contaminant across the first membrane.

3. The system of claim 1 wherein the first open fraction of the porous matrix is greater than or equal to 50%.

4. The system of claim 1 wherein each of the first plurality of pores is characterized by a first dimension that is its largest cross-sectional dimension, and wherein the contaminant is characterized by a second dimension that is its smallest dimension, and further wherein the first dimension is less than or equal to 30% of the second dimension.

5. The system of claim 1 further comprising:
a first conductor disposed on a first surface of the first membrane, the first surface being proximate to the first chamber; and
a second conductor disposed on a second surface of the first membrane, the second surface being distal to the first chamber;
wherein the first conductor and second conductor are operative for providing a first electric field that gives rise to a first repulsion zone that repels at least one charged element.

6. The system of claim 5 wherein the first repulsion zone is an alternating repulsion zone.

7. The system of claim 1 further comprising:
a third chamber that is fluidically coupled with a third outlet;
a second membrane that includes a second grid and a second plurality of pores that defines a second open-fraction porous matrix that is operative for allowing the liquid to pass through the second membrane;
a first conductor disposed on a first surface of the first membrane, the first surface being proximate to the first chamber;
a second conductor disposed on a second surface of the first membrane, the second surface being distal to the first chamber;
a third conductor disposed on a third surface of the second membrane, the third surface being proximate to the first chamber; and
a fourth conductor disposed on a fourth surface of the second membrane, the fourth surface being distal to the first chamber;
wherein the first conductor and second conductor are operative for providing a first electric field that gives rise to a first repulsion zone that repels at least one charged element; and
wherein the third conductor and fourth conductor are operative for providing a second electric field that gives rise to a second repulsion zone that repels at least one charged element.

8. A method for separating a liquid from a fluid comprising a contaminant, the method comprising:
providing a first membrane that is located between a first chamber and a second chamber, wherein the first membrane includes;
a first grid having a first surface proximal to the first chamber and a second surface proximal to the second chamber; and
a first plurality of pores that extend from the first surface to the second surface;
providing the fluid to the first chamber via an inlet;
enabling a first portion of the liquid to exit the fluid through the first membrane and enter the second chamber; and
enabling a second portion of the liquid and the contaminant to flow from the inlet to a first outlet along the first surface; and
inhibiting the contaminant from flowing from the first chamber to the second chamber through the first plurality of pores.

9. The method of claim 8 wherein the first membrane is provided such that the first plurality of pores is dimensioned and arranged to mitigate perturbation of the flow of the contaminant across the first membrane.

10. The method of claim 8 wherein the first membrane is provided such that the first open fraction of the porous matrix is greater than or equal to 50%.

11. The method of claim 8 wherein the first membrane is provided such that it includes a first electrode disposed on the first surface and a second electrode disposed on the second surface, and wherein the method further comprises providing a first voltage signal between the first electrode and the second electrode, wherein the first voltage signal gives rise to a first repulsion zone that repels a first charged element.

12. The method of claim 11 wherein the first voltage signal is an alternating current (AC) signal.

13. The method of claim 11 further comprising:
providing a second membrane that is located between the second chamber and a third chamber, wherein the second membrane includes;
a second grid having a third surface proximal to the second chamber and a fourth surface proximal to the third chamber; and
a second plurality of pores that extend from the third surface to the fourth surface, wherein the plurality of pores enables a flow of the liquid through the second membrane;
providing a second voltage signal between the third electrode and the fourth electrode, wherein the second voltage signal gives rise to a second repulsion zone that repels a second charged element.

14. The method of claim 13 wherein the first charged element is a cation and the second charged element is an anion.

15. The method of claim 13 wherein the first charged element is an anion and the second charged element is a cation.

16. A fluid treatment system comprising:
a first chamber having an inlet and a first outlet;
a second chamber having a second outlet;
a third chamber having a third outlet;
a first membrane comprising a first grid having a first surface and a second surface, a first plurality of pores that extend between the first surface and the second surface, a first electrode disposed on the first surface, and a second electrode disposed on the second surface, wherein the first membrane is located between the first chamber and the second chamber such that the first electrode is proximal to the first chamber and the second electrode is proximal to the second chamber; and
a second membrane comprising a second grid having a third surface and a fourth surface, a second plurality of pores that extend between the third surface and the fourth surface, a third electrode disposed on the third surface, and a fourth electrode disposed on the fourth surface, wherein the second membrane is located between the second chamber and the third chamber such that the third electrode is proximal to the second chamber and the fourth electrode is proximal to the third chamber;
wherein the first electrode and second electrode are collectively operative for developing a first repulsion zone that repels charged elements having a first electrical polarity.

17. The system of claim 16 wherein the inlet is operative for receiving a fluid comprising a liquid and a contaminant, and wherein the first chamber, second chamber, and first membrane are arranged such that the fluid flows from the inlet to the first outlet along the first electrode of the first membrane to enable at least a portion of the liquid to exit the fluid through the first plurality of pores, and further wherein the first membrane is dimensioned and arranged to inhibit the flow of the contaminant through the first plurality of pores.

18. The system of claim 16 wherein the third electrode and fourth electrode are collectively operative for developing a second repulsion zone that repels charged elements having a second electrical polarity that is different from the first electrical polarity.

19. The system of claim 16 wherein the first electrical polarity is positive.
